(19) United States
(12) Patent Application Publication
(10) Pub. No.: US 2017/0018046 A1
(43) Pub. Date: Jan. 19, 2017

(54) COMPUTER-ASSISTED METHOD FOR ASSISTING A USER IN EVALUATING A SET OF PARAMETERS IN AN ELECTRONIC DOCUMENT

(71) Applicant: Celant Innovations, LLC, Wilmington, DE (US)

(72) Inventors: Jason Yoon-Ho Lee, Brooklyn, NY (US); David Charles Rogers, New York, NY (US); Miriam Ann Hastie, New York (US)

(21) Appl. No.: 14/800,254

(22) Filed: Jul. 15, 2015

(51) Int. Cl. G06Q 50/18; G06F 17/21; G06Q 10/10; G06F 17/22

(52) U.S. Cl. CPC G06Q 50/18; G06F 17/2211; G06F 17/2288; G06F 17/212; G06Q 10/10

(57) ABSTRACT

A computer-assisted method and system for assisting a user in evaluating a set of parameters in an electronic document. The method comprises accessing a first electronic variable data document having a first set of parameters provided by a first user corresponding to a first set of parameters in an electronic negotiated document. Then, the first electronic variable data document is compared to a second electronic variable data document. Differences between the first set of parameters of the first electronic variable data document and a second set of parameters of the second electronic variable data document are identified. The differences are categorized and labeled. A comparison report is generated including the categorized and labeled differences and an interpretation of the identified differences between the first set of parameters of the first electronic variable data document and the second set of parameters of the second electronic variable data document.

### STATEMENT REGARDING FEDERALLY SPONSORED RESEARCH OR DEVELOPMENT

None.

### REFERENCE TO A “SEQUENCE LISTING”

Not applicable.

### BACKGROUND OF THE INVENTION

Field of the Invention

The present invention relates to the field of computer implemented document assembly systems, and more specifically, to enhancing the ability of a user to detect and evaluate differences in sets of parameters of a draft electronic document.

Description of Related Art

It is known in the art to provide document assembly systems for building documents. Further, it is known in the art to provide a system for compare two or more documents. Writers in all arenas need methods and systems to build standard documents and identify changes made therein. In the area of law, attorneys frequently build contracts electronically based on existing provisions and documents. The attorney for the other party then diligently reviews and analyzes the changes made. Then, the attorney for the other party revises the contract to reflect his or her client's preferred positions, including by revising particular provisions, inserting provisions, and deleting provisions. These changes in the electronic contract must then be diligently reviewed and evaluated by opposing counsel and the client.

Similarly, businesses attempting to secure financing for mergers, acquisitions, intangible assets, and/or tangible assets may submit applications to several banks or lending institutions and, as a result, receive multiple commitment letters or term sheets indicating the terms and conditions under which each bank or lending institution is willing to loan money to the borrower. The borrower typically negotiates the commitment letters or term sheets with each lender to obtain a loan document that is most consistent with the borrower's objectives. Negotiating such commitment letters or term sheets is time-consuming and difficult for both the lender and the borrower because each revised term must be identified, evaluated and resolved. Further, mistakes are often made when the term sheet is tediously converted into a full agreement.

Typically, to identify changes made during the negotiation stage, a legal or business document is compared using the track-changes or document comparison functions in Microsoft® Word document word processing software or by using another program, such as the Workshare™ Compare file comparison program. These programs allow a first document to be compared to a second document and display the changes made by, for example, underlining new content and striking out deleted content, sometimes referred to as “redlining”. These existing methods have a number of limitations. First, the user is typically presented with the entire document to review, regardless of whether or not certain sections of the document were revised by the other party. This presents an overwhelmingly large document to review. Further, when multiple versions of a document must be reviewed and analyzed, for example, in the lender-borrower context, identifying and evaluating in the issues among all the redlined documents is especially difficult. Second, since the comparison merely reports a change without evaluating the difference between the two documents, the user must conduct a separate evaluation of each change made in the document. That is, a user must still evaluate each identified change to determine how it differs over the preceding content. Third, the underlining and striking out of content does not identify the issues present in the document. Thus, a user must track and analyze each individual issue in each document: a daunting task, especially when multiple contracts are being negotiated with multiple parties, for example, in the lender-borrower context. Further, since borrowers typically prefer to move quickly to the funding phase, the preceding commitment letter phase is sometimes negotiated hastefully such that important issues are overlooked.

Accordingly, is a long felt need for some solutions that address at least one or more of the aforementioned limitations.

### BRIEF SUMMARY OF THE INVENTION

A method according to one embodiment is for assisting a user in evaluating a set of parameters in an electronic document representing a first transaction between at least two parties. The method comprises the set of accessing a computer system to obtain a first electronic variable data document having a first set of parameters provided by a first user corresponding to a first set of parameters in a first electronic negotiated document. The method further comprises the step of comparing with the computer system the first electronic variable data document to a second electronic variable data document, the second electronic variable data document having a second set of parameters corresponding to a second set of parameters in a second electronic negotiated document created before the first electronic variable data document. The method further comprises identifying with the computer system differences between the first set of parameters of the first electronic variable data document and the second set of parameters of the second electronic variable data document, wherein the differences are categorized and labeled. The method also comprises generating with the computer system a comparison report including the categorized and labeled differences and an interpretation of the identified differences between the first set of parameters of the first electronic variable data document and the second set of parameters of the second electronic variable data document, wherein a second user provides additional input by accepting, rejecting, or countering each of the parameters of the first electronic variable data document. The method further comprises storing the accepted, rejected and countered parameters in a third electronic variable data document.

According to another aspect there is provided a computer-assisted method for assisting users in evaluating a set of parameters in an electronic document representing a first transaction between at least two parties. The method comprises receiving at a computer system a plurality of first documents generated by a plurality of users interested in entering a transaction with a party, each document comprising a set of parameters corresponding to answers provided by one of the plurality of users to a set of predefined choices and/or interview questions. The method further comprises comparing with the computer system at least one of the plurality of first documents to at least another one of the first documents to identify differences between the sets of parameters in the documents. The method also comprises reporting in a comparison file generated by the computer system, the comparison file having an accept, reject or counter selector, an interpretation of identified differences between the sets of parameters.

According to another aspect there is provided a computer-assisted method for assisting a user in evaluating a set of parameters in multiple electronic documents representing a potential first transaction between at least two parties. The method comprises obtaining a plurality of electronic documents from a set of third parties, each electronic document having a set of parameters corresponding to a relevant transaction. The method further includes comparing with a computer system each of the plurality of electronic documents to a reference document to generate a comparison report interpreting differences between the sets of parameters in the plurality of electronic documents and the reference document and providing a proposed resolution of the differences for at least one parameter, wherein the user provides additional input by accepting, rejecting, or revising each proposed resolution. The method further includes generating with the computer system a second set of electronic documents incorporating the additional input of the user, wherein the sets of parameters in each document are customized for each third party. Further, the method includes storing the accepted, rejected and revised parameters made by the user in a computer memory.

According to yet another aspect there is provided a computer system for assisting a user in evaluating a set of parameters in multiple electronic documents representing a potential first transaction between at least two parties, the computer system having one or more processors, one or more computer-readable storage devices and program instructions stored on at least one of the one or more storage devices for execution by at least one of the one or more processors. The computer system comprises program instructions to compare a first electronic variable data document having variable entries corresponding to a first set of parameters from a first electronic negotiated document to a second electronic variable data document, the second electronic variable data document having variable entries corresponding to a second set of parameters from a second electronic negotiated document. The computer system further comprises program instructions to identify differences between the first set of parameters of the first electronic variable data document and the second set of parameters of the second electronic variable data document, wherein the differences are categorized and labeled. The computer system also comprises program instructions to generate a comparison report including the categorized and labeled differences and an interpretation of the identified differences between the first set of parameters of the first electronic variable data document and the second set of parameters of the second electronic variable data document, wherein a second user provides additional input by accepting, rejecting, or countering each of the parameters of the first electronic variable data document. The computer system further comprises program instructions to store the accepted, rejected and countered parameters in a third electronic variable data document.

According to yet another aspect there is provided a computer-assisted method for assembling an electronic document. The method comprises the step of displaying in a first area of a display screen a set of predefined questions and/or choices relating to a set contractual provisions in an electronic document and in a second area of the display screen the set of contractual provisions. The method further comprises populating contemporaneously, in response to a first user answering the set of predefined questions corresponding to the set of contractual provisions, the set of variable entries included in predefined contractual provisions in the second area of the computer screen to provide the first user a real-time revision of the electronic document.

### BRIEF DESCRIPTION OF THE SEVERAL VIEWS OF THE DRAWING(S)

FIG. 1 is a block diagram showing a system for facilitating a negotiation of a transaction between at least two parties.

FIG. 2 is an example of a screen display of an initial set-up page of a term sheet.

FIG. 3A is an example of a screen display of the system for assisting a user in setting a set of parameters in an electronic document showing a variable entries section and a source document.

FIG. 3B is another example of a screen display of the system for assisting a user in setting a set of parameters in an electronic document showing a variable entries section and a source document.

FIG. 3C is another example of a screen display of the system for assisting a user in setting a set of parameters in an electronic document showing a variable entries section and a source document.

FIG. 3D is yet another example of a screen display of the system for assisting a user in setting a set of parameters in an electronic document showing a variable entries section and a source document.

FIG. 4 is a flowchart of a method of assisting a user in evaluating a set of parameters in an electronic document representing a transaction between at least two parties.

FIG. 5 is a flowchart of additional steps in a method of assisting a user in evaluating a set of parameters in an electronic document representing a transaction between at least two parties.

FIG. 6 is an example of a screen display of an issues grid provided to a user for evaluating a set of parameters in an electronic document representing a transaction between at least two parties.

FIG. 7 is another example of a screen display of an issues list provided to a user for evaluating a set of parameters in an electronic document representing a transaction between at least two parties.

FIG. 8 is yet another example of a screen display of an issues grid provided to a user for evaluating a set of parameters in an electronic document representing a transaction between at least two parties.

FIG. 9 is another example of a screen display of an issues list provided to a user for evaluating a set of parameters in an electronic document representing a transaction between at least two parties.

### DETAILED DESCRIPTION OF THE INVENTION

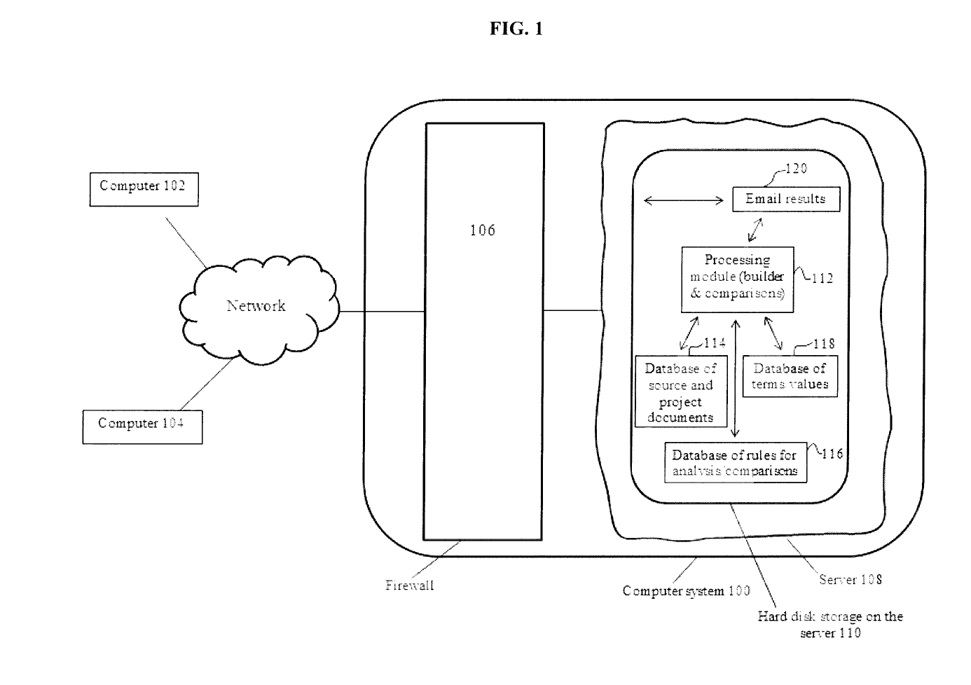

According to one embodiment of the present invention, it provides a computer-implemented method and system for assisting a user in evaluating a set of parameters in an electronic document representing a first transaction between at least two parties. FIG. 1 depicts a block diagram of a system according to an illustrative embodiment. The system in one embodiment facilitates a bank financing transaction between a lender and a borrower. The term “lender” will be used generally to refer to a lending institution in a loan transaction and its agents or others acting on behalf of the lending institution, including, but not limited to the lender's attorneys. The term “borrower” will be used generally to refer to an entity or individual seeking financing from a lender and its agents or others acting on behalf of the bank, including, but not limited to the borrower's attorneys. It should be appreciated that the system can be used to negotiate a structured transaction between more than one lender or borrower. Further, it should be appreciated that system is not limited to a loan transaction from a lending institution and can be applied to any structured negotiation involving at least two parties.

The lender operates a computer 102 and borrower operates a computer 104 to remotely access the computer system 100 via a network, for example, a local area network (LAN), public wide area network (WAN), such as the Internet, or a private WAN. Although FIG. 1 does not include network routers, switches and other equipment required for network communications between each computer 102, 104 and the computer system 100, it should be appreciated that they are within the scope of this disclosure. In an embodiment, the computer system 100 is accessed remotely through a web browser. Alternatively, the computer system 100 is accessed through client software. In an alternative embodiment, the computer system 100 is implemented in both or one of computers 102 and 104.

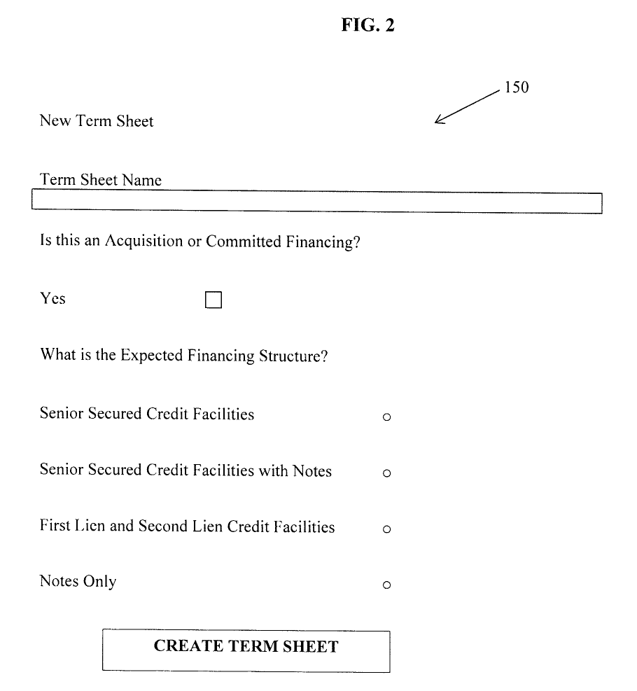

Referring to FIG. 1, the computer system 100 includes firewall 106 and server 108. A hard disk storage 110 is stored on server 108. A lender using computer 102 or borrower using computer 104 accesses the processing module 112 to select a type of source document from the source document database 114 having a plurality of templates for a user to select as a base document. In a bank loan transaction, for example in a middle market setting, a lender, having received an application for a loan from a borrower, can select a term sheet, commitment letter, or credit agreement from a plurality of source documents available in the source document database 114. In an auction setting involving first-tier private equity sponsors, on the other hand, the sponsor or borrower can select a term sheet or credit agreement from a plurality of source documents available in the source document database 114. Thus, when used herein, the term “user” refers to either the lender or the borrower in a bank loan transaction or to either party in other negotiated transactions. The processing module 112 prompts the user to provide a set of desired variable entries. The variable entries can include, for example, questions for the user to answer, pre-defined choices for the user to select, and/or prompts for variable data to be entered. In accordance with one embodiment, an initial set-up page 150 as shown in FIG. 2 is presented to the user wherein an initial set of variable entries is prompted. The initial variable entries selected by the user are compared to rules stored in a database of rules 116. The database of rules 116 and the processing module 112 include a knowledge base that stores information regarding various input associations. That is, entry of a particular variable will result in a particular parameter in the source document.

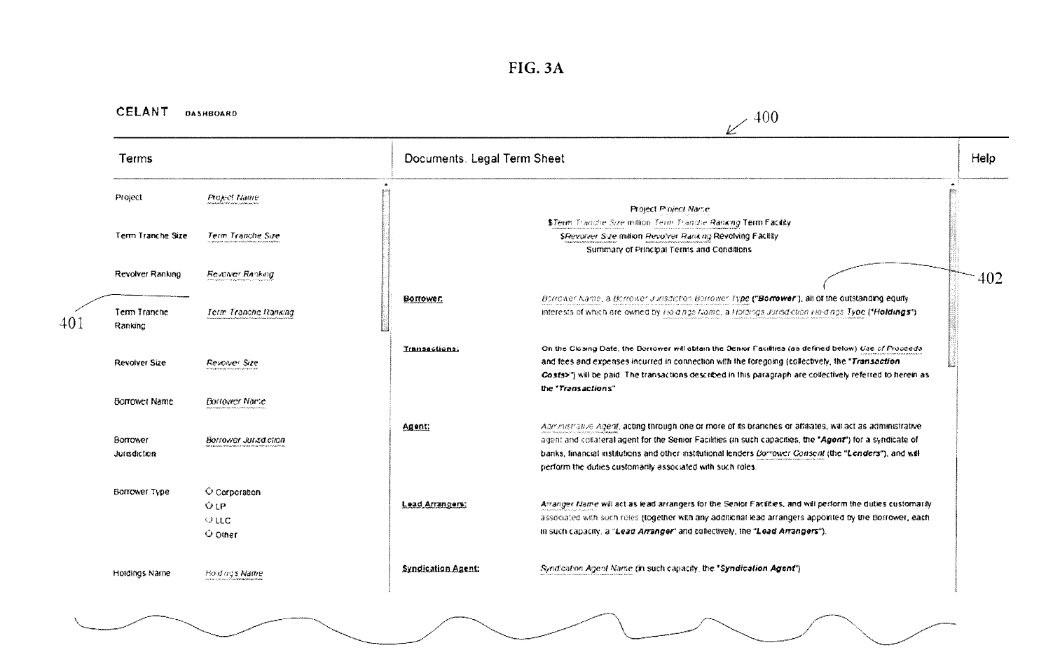

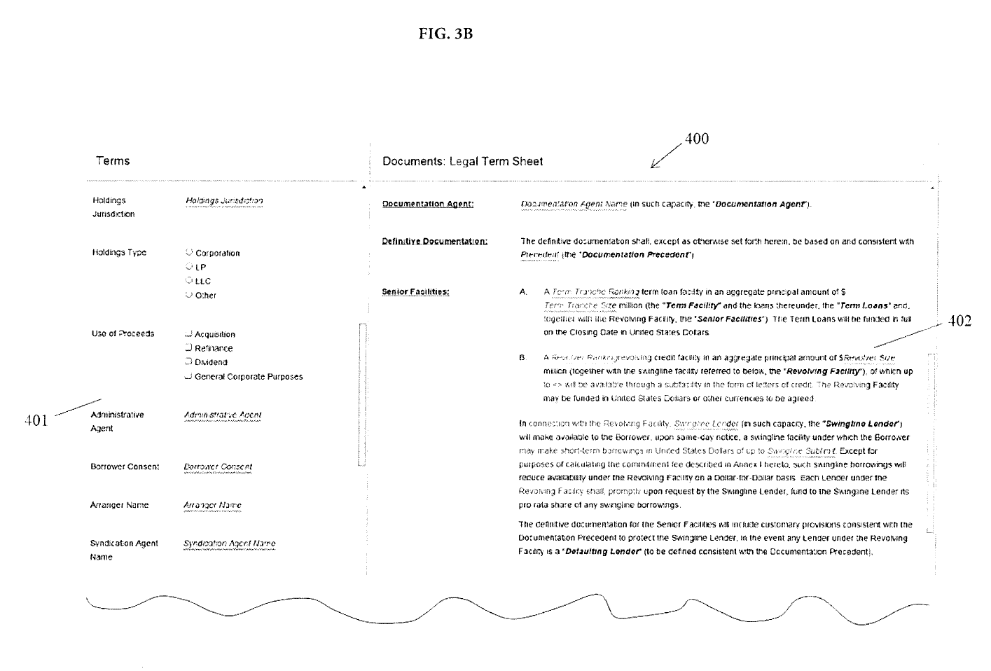

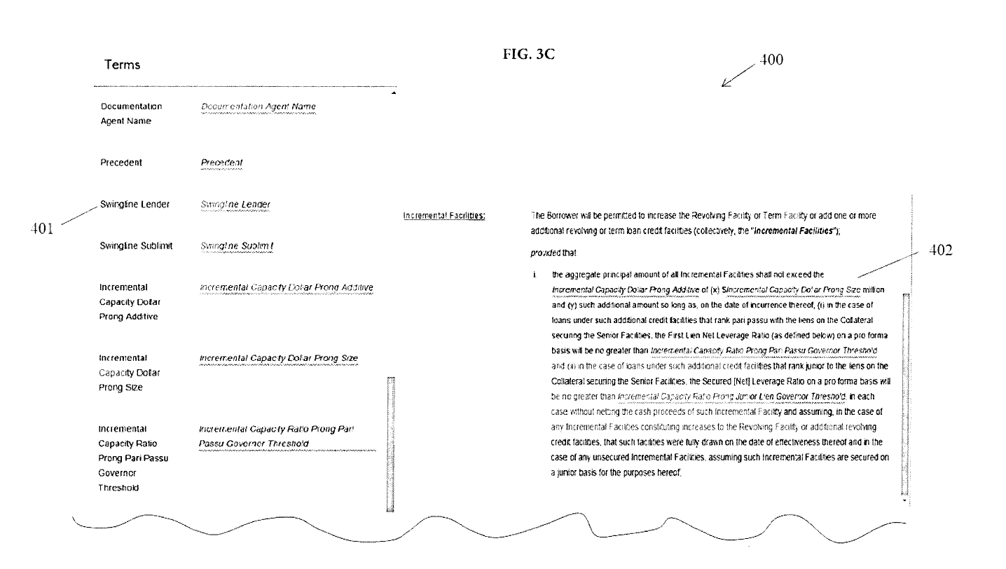

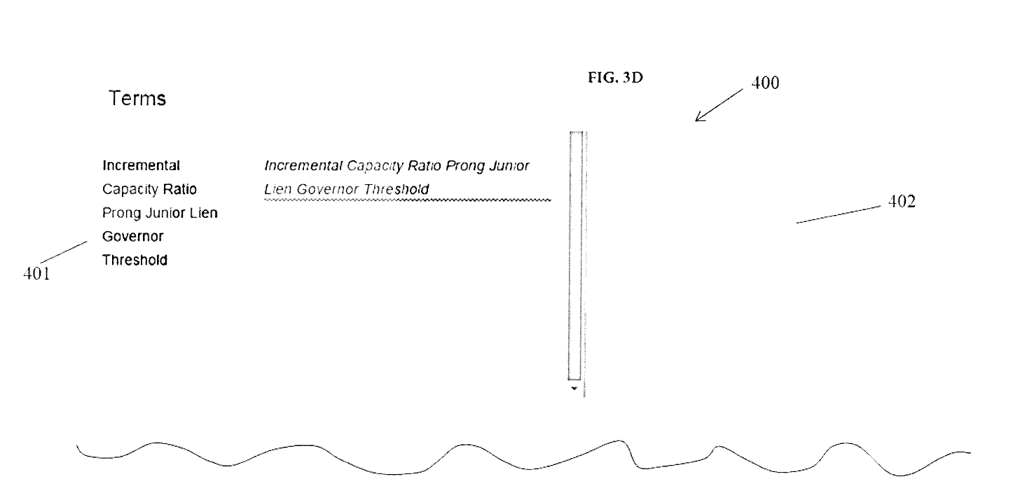

Once the desired information is entered into an initial set-up page 150, the processing module 112 generates and displays the source document 402 and a variable entries section 401 on a display screen as shown in FIGS. 3A-3D. The source document 402 is generated by the user entering a first set of desired variable entries prompted in the initial set-up page 150. In an embodiment, for example, a term sheet for a bank loan can be created by a user first entering into an initial set-up page 150 the desired name of the project or the term sheet in a variable entry data field and by answering questions regarding the transaction. At least some of the questions may include pre-defined choices for the user to select. The source document 402, having provisions determined based on the user's initial input, is displayed on a portion of the display screen 400 and includes additional variable entries for the user to complete. The source document 402 is structured with various headers and subsection headers required in the negotiated document. Another portion of the display screen 400 includes a variable entries section 401. A user enters the requested information in the variable entries section 401 to complete a finished document to be negotiated. For example, in a bank loan term sheet context, a user can add, among others, the following information: Project name, Term Tranche Size, Revolver Ranking, Term Tranche Ranking, Revolver Size, Borrower Name, Borrower Jurisdiction, Borrower Type, Parent Company's Name, Parent Company's Jurisdiction, Parent Company's Type, Use of Proceeds, Administrative Agent Name, Arranger Name, Syndication Agent Name, Documentation Agent Name, Documentation Precedent, Swingline Lender Name, Swingline Sublimit, Incremental Facility Capacity. Thus, in an embodiment, one area of the display screen 400 can contain variable entry prompts corresponding to a set of contractual provision parameters in an electronic document while another area contains the set of contractual provision parameters requiring the additional variable entry information. As the user enters information into the variable entries section 401, the source document 402 is contemporaneously populated. That is, each alphanumerical character or revision of the alphanumerical character entered by the user into variable entries section 401 appears in the source document 402 immediately, without requiring the page to be reloaded. In one embodiment, this real-time updating of the source document 402 is provided by Ajax technology or HTML5, wherein the web application can asynchronously send and retrieve data from a server (or the data is “pushed” by the server to the web application) such that the existing page is not disrupted. The variable entries entered by the user in the variable entries section 401 are compared to rules stored in a database of rules 116. Thus, entry of a particular parameter in the variable entries provided by user 200 will correspond to a particular parameter provided in the resulting electronic negotiated document.

The user 200, in one aspect, can revise the pre-existing provisions set forth in the source document 402 directly in the display screen 400. When making such changes to the source document 402, revisions can be displayed in redline-style formatting. For example, any additions can be shown in blue text and have a double underline and deletions can be shown in red text with a strikethrough. A user 200 can remove the redline-style formatting by clearing the formatting wherein added text is displayed in the same font as the pre-existing provisions and deleted text is removed. The variable entry information provided by the user 200 in the variable entries section 401 can be displayed in redline-style formatting in the source document section 402 when the user 200 is building a document. Similarly, the second user 250 can edit the source document 402 wherein the edits made by the second user 250 are displayed in redline-style formatting. If the second user 250 is providing variable entry information in the variable entry section 401 of the display screen 400, the variable entries can also appear in redline-style formatting. It should be appreciated that the edits of the user 250 can be distinguished between the edits of user 200. For example, the additions and deletions made by user 250 can be shown in other colors.

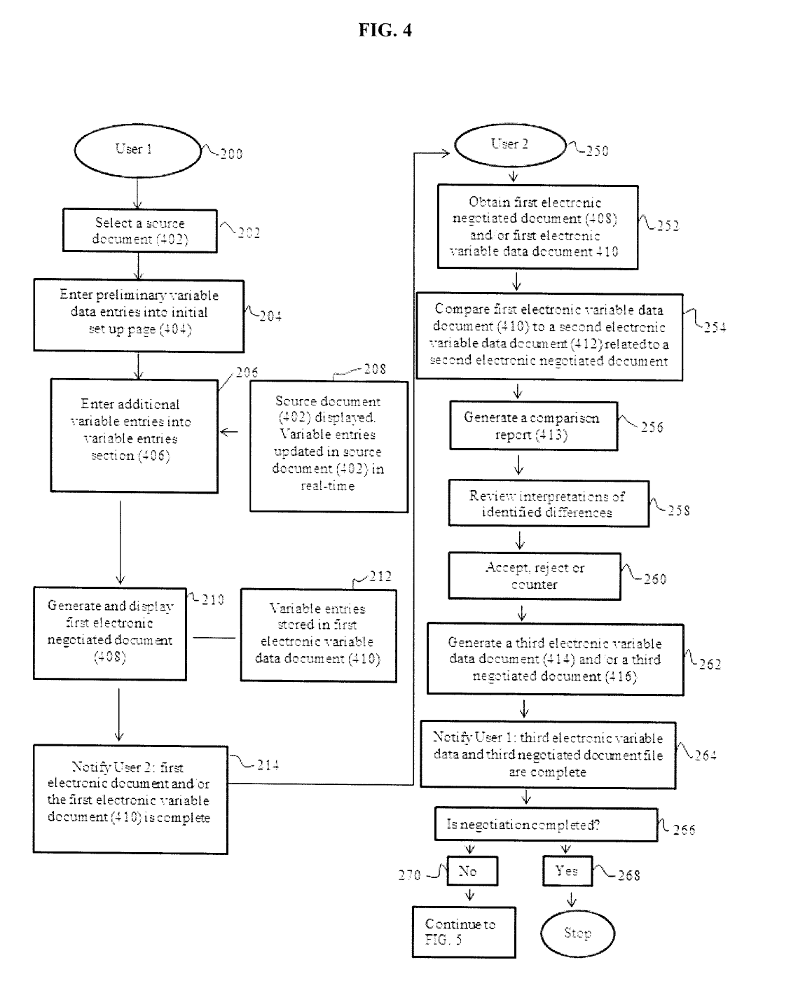

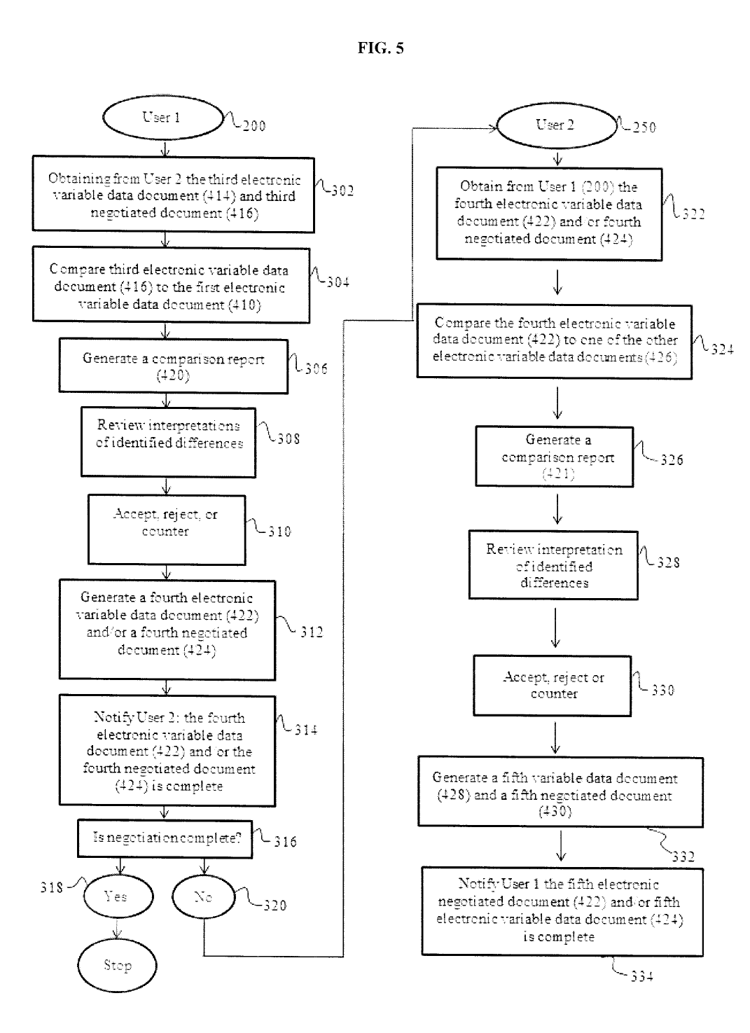

FIGS. 4 and 5 show a computer-assisted method for negotiating a transaction between user 200 and user 250. Each user 200, 250 logs into the computer system, for example a web-accessed computer system 100, to negotiate a legal document. As shown generally in these figures, after logging into the computer system 100, user 200 selects the type of source document 402 according to step 202. In a loan transaction, user 200 can select, for example, one of the following source documents: a new business term sheet, a business term sheet from an existing transaction, a new detailed term sheet (FIG. 2), a detailed term sheet from an existing transaction, a new credit agreement, or a credit agreement from an existing transaction.

A user 200 is then provided an initial set up page 204 where the user 200 enters certain preliminary variable data 204. The processing module 112 uses the preliminary variable data to generate and displays a source document 402 as a base document. In one aspect, the source document 402 includes contractual provisions with blank portions to be completed by the user 200 as variable entry data. The user 200 enters data into the variable entries section 401 according to step 206 and such data is contemporaneously updated into the source document 402 of the display screen 400 as provided in step 208. When the user 200 has entered the applicable variable data, or sooner if desired, an electronic negotiated document 408 is generated according to step 210 and the variable entries provided by the user 200 are stored in an electronic variable data document 410 according to step 212. For example, if user 200 elected to build a term sheet, a term sheet comprising all parameters corresponding to the variable entries is provided as the electronic negotiated document 408. If the user 200 elected to build a credit agreement a full credit agreement comprising all parameters corresponding to the variable entries can be provided as the electronic negotiated document 408. While a credit agreement or other financial transaction documents are contemplated, it should be appreciated that the computer system 100 can be used to build other types of documents, including but not limited to an intellectual property licensing agreement, employment agreement, real estate documents, trust and estates documents, and other documents that have certain standard language used in a designated contract type. It should be apparent that the user 200 can have further opportunities to customize and modify the parameters of the electronic negotiated document 408. The user 200 can revise the pre-existing provisions set forth in the source document 402 directly in the display screen 400. When making such changes to the source document 402, revisions can be displayed in redline-style formatting as described supra.

A particular project or transaction may include multiple negotiated documents that are associated with each other. In one aspect, for example, a particular project or transaction can include the following associated documents: a credit agreement, security agreement, and guarantee agreement. Thus, a user 200 can prepare multiple negotiated documents in one project. In one aspect, each negotiated document is updated simultaneously when certain variable data is updated by user 200. That is, for example, if user 200 corrects the name of a party to a transaction, the name is automatically corrected in all the associated documents.

Once the electronic negotiated document 408 is generated, the second user is notified 214. In a computer assisted web-based method, the electronic negotiated document 408 and the electronic variable data document 410 are stored on a hard disk storage 108 on the server 110 and can be accessed by the other party to an agreement, user 250, upon notification that the negotiated document 408 and/or variable data document 410 are complete. For example, in an embodiment, user 200 can notify user 250 via email 120 that the documents are ready for review. Alternatively, the user 200 can electronically provide copies of the negotiated document 408 and variable data document 410 to user 250. In a computer assisted installed method, for example, the electronic negotiated document 408 and the electronic variable data document 410 are stored on a hard disk storage on the computer of the first user 200 or on a hard disk storage of a server of user 200. In accordance with this embodiment, the negotiated document 408 and the variable data document 410 would be provided electronically to user 250 by user 200. In one aspect, user 200 can email the documents to user 250.

In one aspect, the electronic variable data document 410 is a data source document containing the variable entries of at least one user. The electronic variable data document 410 can be a .save file, an Excel® spreadsheet, a database storing information, or similar document or file. Further, the electronic negotiated document 408 can be in various formats such as PDF, DOC, DOCX, TXT, HTML, XML, RTF and the like.

While it is contemplated that both the electronic negotiated document 408 and the electronic variable data document 410 are provided to the second user 250, it should be appreciated that user 250 can be provided only the electronic negotiated document 408 or electronic variable data document 410. At this stage of a negotiation, user 250 can create a comparison report, as described infra, by receiving or having access to only the electronic variable data document 410.

As provided in FIG. 4, upon user 250 obtaining the electronic variable data document 410 and/or the electronic negotiated document 408, as provided in step 252, the user 250 can compare the electronic variable data document 410 to a comparison document 412 to generate an issues list identifying and interpreting differences between the documents 410, 412 according to step 254. The comparison document 412 used can be one of many electronic variable data documents stored in a database 118 on the server 110. In an embodiment, the comparison document 412 is an electronic variable data document having variable entries corresponding to a set of parameters from a negotiated document from a prior project or transaction or a prior negotiated session. The prior project or transaction can be one among the same parties. Thus, the user 250 is able to determine the differences between the terms in the negotiated document 408 and a past negotiated document with the same party. In another aspect, the comparison document 412 is an electronic variable document from a prior transaction with a different party. By comparing the current document 410 to a prior transaction with a different party, user 250 is able to determine how the current transaction differs over past deals and thus, deduce whether the current terms are consistent with the marketplace. In yet another embodiment, document 410 is compared to multiple comparison documents. For example, if a borrower has applied for a bank loan from multiple lenders, the borrower can determine the differences among the negotiated documents by comparing one of the variable data documents received from a lender to variable data documents received from other lenders, which information can be presented on a grid with different lenders' positions listed on separate columns. On the other hand, a lender may desire to compare the variable data document to variable data documents received from other clients or law firms regarding the same transaction or a different transaction or received from the same clients but from different dates.

A comparison report 413 is generated 256 and displayed to user 250. In one aspect, the comparison report 413 is automatically generated once the user 250 selects the desired comparison document 412. The term automatically includes without any user input as well as without any substantive user input. That is, a confirmatory input or response from the user, prior to the processor completely the given task is deemed automatic. The comparison report sets forth a summary of the differences between documents 410 and 412. In one aspect, the comparison report 413 shows differences between the first set of parameters of variable data document 410 and the set of parameters of electronic variable data document 412, which differences are interpreted, categorized, and labeled.

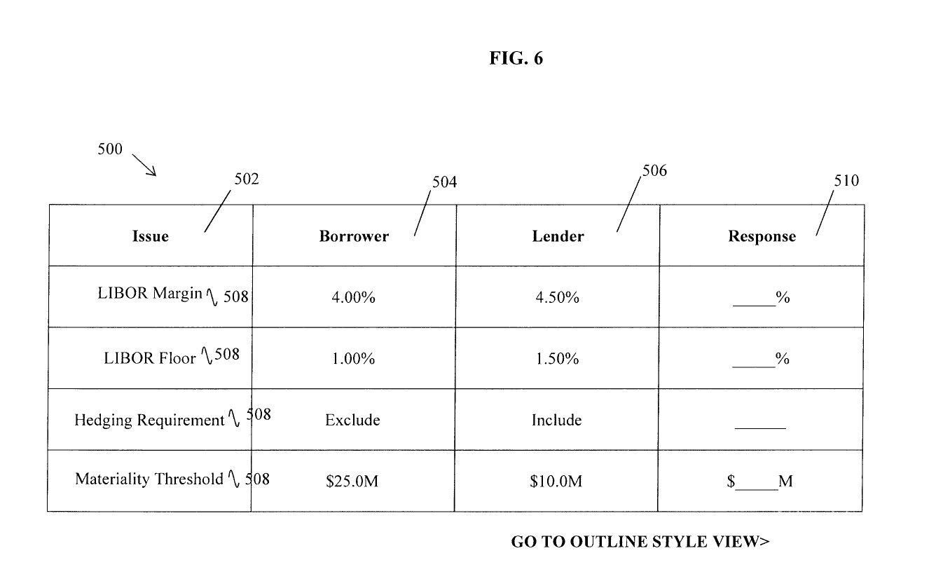

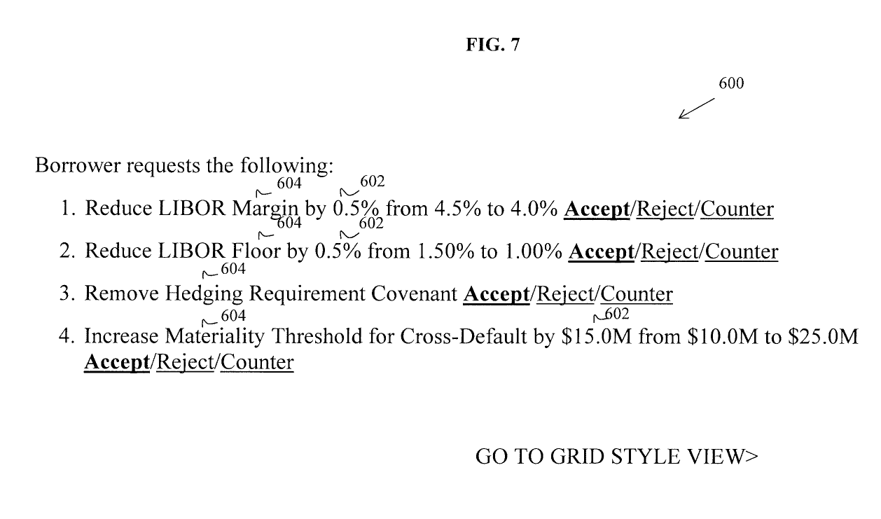

As shown in FIGS. 6 and 7, the comparison report 500, 600 identifies only those differences between the comparison document 413 and the variable data document 410. That is, instead of providing a comparison that shows the entire text of the electronic negotiated document 408 wherein the additions and deletions are distinguished by redlining, a summary of the differences is presented to the user 250. The summary includes a categorized and labeled difference (issue) 502, if any. The difference is either presented by showing the proposed terms 504 by user 200 and the new proposal 506 by user 250 as shown in FIG. 6, or by showing instead or in addition the calculated difference 602 between the proposal set forth by user 200 and the new proposal set forth by user 250 as shown in FIG. 7. The difference is categorized and labeled by providing a short form issue description 508, 604. As shown in FIGS. 6 and 7, the short form issue description 508, 604 examples include: LIBOR Margin; LIBOR Floor; Hedging Requirement; and Materiality Threshold. For illustrative purposes, where the borrower includes an LIBOR Margin of 4.00% and a Lender has increased the LIBOR Margin to 4.50%, a typical comparison program would provide a complete sentence indicating the change using a form of redlining: “LIBOR Margin” shall mean, with respect to each LIBOR Loan that is an Initial Term Loan, 4.50%.” As shown in FIG. 6, in the present invention, the comparison report 500 includes a summarized heading is provided to describe the issue 508, with the different percentages 504, 506 set forth in grid form. As shown in FIG. 7, the issues are presented in the comparison report 600 in outline form by indicating that the borrower requests parameters to be “increased or decreased” “removed or added,” “include or exclude” by a desired amount. One of the differences provided in outline style from the lender's perspective is outlined as follows: “Borrower requests the following: Reduce LIBOR Margin by 0.5% from 4.5% to 4.0%. Thus, different LIBOR Margin percentages are not only reported in the comparison report 600, but the change is interpreted as “reduced.” Similarly, FIG. 7 states “Borrower requests the following: remove Hedging Requirement Covenant.” Thus, instead of reporting the difference in redlining format in the actual negotiated document, the difference is interpreted as “removed” in the comparison report 600. In an additional aspect, the comparison report 500, 600 also identifies changes to the structured transaction type. For example, if certain covenants and guarantees are removed, the structured transaction can be reported as changed from a high yield deal to an investment grade deal. In addition, certain modification or a combination of modifications of provisions can be provided to be given a commonly used description used by the practitioners in the field; for example, deletion of the quarterly maintenance financial covenant by a party can be described as a request to “convert the agreement into a covenant-lite transaction” or inclusion of the concept of the ‘borrowing base’ in a revolving loan can be described as a request to “convert the agreement from a cash flow based transaction into an asset based loan (ABL) transaction.” It should be noted that the word usage of the issue description may depend on the perspective of the issues list, whether from a lender or a borrower.

Certain changes are beneficial for the borrower while at the same time detrimental for the lender and vice versa. To reflect interpretive meaning and give any value judgments, if any, the system can identify whether certain addition, deletion or modification of the provisions, terms, words or values are “good” or “bad” (by a Boolean value) for the entity from which the perspective is selected. As a general rule, (i) increasing the interest rate or fees, (ii) adding a representation, condition, covenant or event of default or (iii) deleting or reducing an exception to the representation, condition, covenant or event of default to the agreement, in each case, would be detrimental for the borrower while beneficial for the lender. An action that is contrary to standard or expected position may be described as such. For example, an issue regarding an addition of a covenant by a lender may be presented to the borrower simply as the document being requested “to be more restrictive.” However, if a borrower requests an addition of a covenant, the issue may be presented to the lender as “ . . . more restrictive, which is unexpected since it is contrary to typical borrower position.” Identifying unexpected modifications are useful because they often reflect a type of quid pro quo, frequently revealing underlying intentions and compromises (rarely embarrassing mistakes). If no specific scripting had been designated for an issue, the issues list may revert to simple presentation of the wording changes, like the redlining programs mentioned above.

Since the user 250 does not need to review an entire negotiated document for potential changes and since the differences are reported and interpreted, reviewing a negotiated document is faster and more accurate.

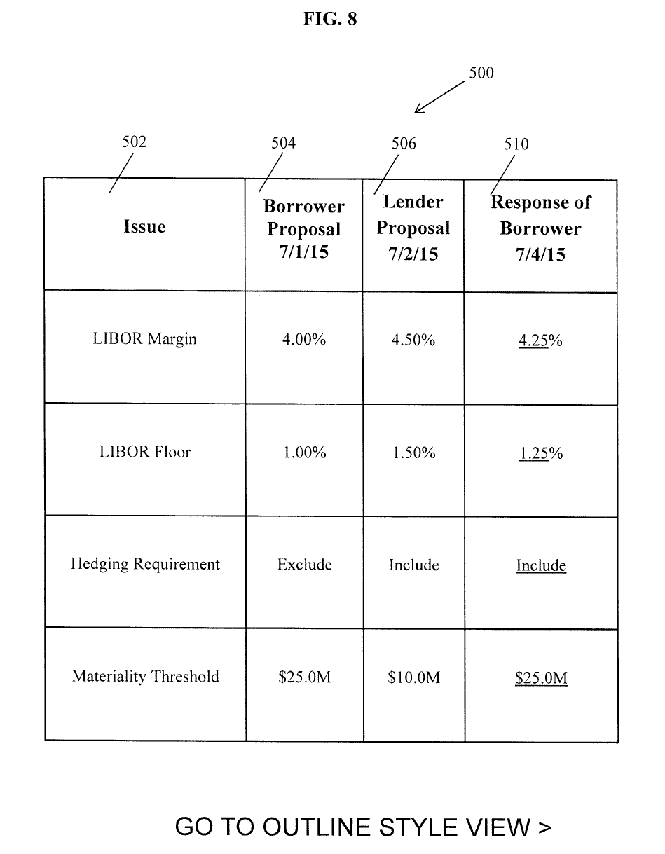

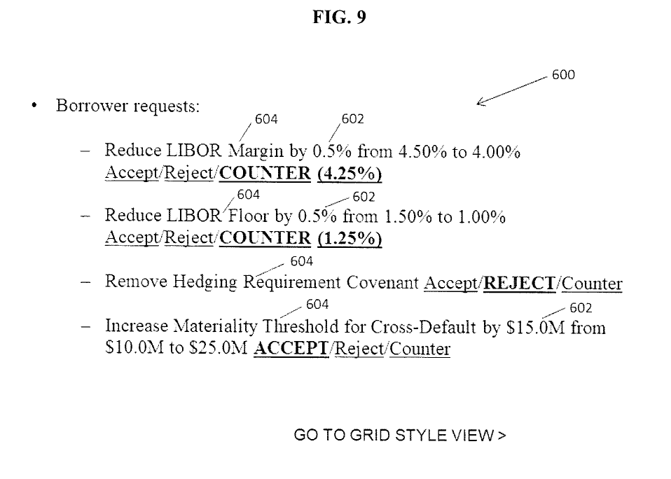

User 250 reviews the differences presented 258 and then determines whether to accept, reject, or counter a proposed term. In one aspect, proposed resolutions are presented to user 250 by the computer system 100, wherein the user 250 accepts, rejects, or counters the proposed resolution. For example, as shown in FIGS. 8 and 9, the responses provided in the response column 510 can be proposed responses generated by the computer or proposed responses generated by the user 250. It should be appreciated that additional columns may be added to the comparison report 500 if multiple comparisons are desired. In one aspect, for example, the variable data document 410 may be compared to multiple comparison documents, for example, comparison documents within the same transaction, but from earlier rounds of negotiation, or comparison documents from different parties in other transactions.

It should be appreciated that each electronic variable data document contains answers to questions or selections to options for each of the variables contained in the template for the document being negotiated. The electronic variable data document in negotiations is compared to an existing variable data document. Where the variables from the two electronic variable data documents being compared differ, the variable is marked as an issue (and conversely, if the values are the same, there is no issue) and will be numbered and listed on the issues grid or issues list. The default option is to ignore non-issue items. Since the user 200, 250 may want to see non-issue items on occasion, the user 200, 250 can select such option, in which case, all or certain selected variables will be subject to comparison.

Generally, the issues grid will present the information on a more mechanical sense, simply listing out the value from each party on separate columns, for example, as provided in FIG. 6. This has the advantage of being able to add additional columns with inputs from different lenders (in a bank loan context) or from the same party but from different dates (which would show convergence of the minds as the negotiation progresses). On the other hand, the issues list will present the information more thoroughly (typically only between two electronic variable data documents for streamlined presentation), attempting to provide additional discerned or calculable information where applicable, for example, as provided in FIG. 7.

More specifically, in an issues list (as opposed to issues grid), if the underlying issue is a numerical difference, then the difference between the numbers in the electronic variable data document are calculated and the change is presented as “increase” or “decrease”, “by” the calculated difference, “from” the starting amount and “to” the ending amount.

Once the user 250 accepts, rejects, or counters the terms proposed by user 200 in the comparison report 500, 600, another electronic variable data document 414 is generated which incorporates the additional input from user 250 according to step 262. Typically, a third version of the negotiated document 416 is also generated. User 250 can also provide certain parameters that are outside the scope of the answered questions provided by the first user. For example, the user 250 can return to display screen 400 having variable entries section 401 and source document 402 to revise the parameters in the variable entries section 401 and/or to revise the provisions in the source document 402. The documents 414, 416 are stored. Specifically, the accepted, rejected and countered parameters are stored in the electronic variable data document 414. Once the electronic variable data document 414 and/or the electronic negotiated document containing the revised parameters 416 is generated, user 200 is notified 264 in the same manner as described supra. In a computer assisted web-based method, the electronic negotiated document 416 and the electronic variable data document 414 are again stored on a hard disk storage 108 on the server 110 and can be accessed by the other party to an agreement, user 200, upon notification that the negotiated document 416 and/or variable data document 414 are complete. The users 200, 250 determine if all negotiations are complete 266. If negotiations are complete 268 no further rounds of negotiations are required. The negotiated document 416 can then be executed by the parties. If further rounds of negotiation are required 270, negotiations will continue.

As shown in FIG. 5, user 200 will receive from user 250 the electronic variable data document 414 and/or the electronic negotiated document 416 according to step 302. In one aspect, the electronic variable data document 416 is compared to electronic variable data document 410 created by user 200 in the first round of negotiations according to step 304. A new comparison report 420 identifying and interpreting the differences between the electronic variable data document 416 and the first electronic variable data document 410 is generated 306. The comparison report 420 sets forth a summary of the differences between the parameters in documents 410 and 414 as similarly provided in comparison reports 500, 600.

User 200 reviews the differences presented 308 and then determines whether to accept, reject, or counter a proposed resolution according to step 310. The User 200 inputs the response into the comparison report 420 and then generates another electronic variable data document 422 incorporating the additional input from user 200 according to step 312. Typically, a fourth version of electronic negotiated document 424 is also generated. User 200 can also provide certain parameters that are outside the scope of the answered questions provided by user 250. The documents 422, 424 are stored. Once the electronic negotiated document 424 is generated, user 250 is again notified 314. In a computer assisted web-based method, the electronic negotiated document 424 and/or the electronic variable data document 422 are again stored on a hard disk storage 108 on the server 110 and can be accessed by the other party, user 250, by logging into the system upon notification that the negotiated document 424 and/or variable data document 422 are complete. Then, the users 200, 250 determine if all negotiations are complete 316. If negotiations are complete 318 no further rounds of negotiations are required and the negotiated document 424 can be prepared for execution. If further rounds of negotiation are required 320, negotiations will continue.

Specifically, user 250 will receive from user 200 the electronic variable data document 422 according to step 322. User 250 can also receive the electronic negotiated document 424 as described supra. The electronic variable data document 422 is compared to one of many electronic variable data documents 426 according to step 324 as provided supra. A new comparison report 421 identifying and interpreting the differences between the electronic variable data document 422 and the selected variable data document 426 is generated 326. The variable data document 426 used as the comparison document is typically the third electronic variable data document 416, however, other comparison documents can be selected by user 250 as described supra. User 250 reviews the differences presented according to step 328 and then according to step 330 determines whether to accept, reject, or counter each difference, if any. The User 250 inputs responses into the comparison report 421 or accepts proposed resolutions and then generates another electronic variable data document 428 incorporating the additional input from user 250 according to step 332. Typically, a fifth version of the electronic negotiated document 430 is also generated. User 250 can also provide certain parameters that are outside the scope of the answered questions provided by user 200. Any revisions and accepted, rejected and countered parameters are stored in the electronic variable data document 428. Once the electronic negotiated document 430 and/or variable data document 428 is generated, user 200 is notified 334. The users 200, 250 determine if all negotiations are complete. If negotiations are complete, no further rounds of negotiations are required and the negotiated document 430 can be prepared for execution. If further rounds of negotiation are required 320, negotiations will continue in a similar manner as set forth in FIG. 5.

The forgoing is considered as illustrative only of the principles of the present invention. Further, since numerous modifications and changes will readily occur to those skilled in the pertinent art, it is not desired to limit the present invention to the exact construction and operation shown and described herein, and accordingly, all suitable modifications and equivalents can be resorted to, falling within the scope of the present invention.

1. A computer-assisted method for assisting a user in evaluating a set of parameters in an electronic document representing a first transaction between at least two parties comprising:
(a) accessing a computer system to obtain a first electronic variable data document having a first set of parameters provided by a first user corresponding to a first set of parameters in a first electronic negotiated document;
(b) comparing with the computer system the first electronic variable data document to a second electronic variable data document, the second electronic variable data document having a second set of parameters corresponding to a second set of parameters in a second electronic negotiated document created before the first electronic variable data document;
(c) identifying with the computer system differences between the first set of parameters of the first electronic variable data document and the second set of parameters of the second electronic variable data document, wherein the differences are categorized and labeled;
(d) generating with the computer system a comparison report including the categorized and labeled differences and an interpretation of the identified differences between the first set of parameters of the first electronic variable data document and the second set of parameters of the second electronic variable data document, wherein a second user provides additional input by accepting, rejecting, or countering each of the parameters of the first electronic variable data document; and
(e) storing the accepted, rejected and countered parameters in a third electronic variable data document.

2. The computer-assisted method of claim 1 further comprising:
(f) generating with the computer system a third set of parameters in the third electronic variable data document by the second user entering the additional input directly in the comparison report, wherein certain parameters in the third electronic variable data document are outside the scope of the parameters provided by the first user.

3. The computer-assisted method of claim 1 further comprising:
(f) generating with the computer system the third set of parameters for the third electronic variable data document by the second user answering interview questions and selecting predefined choices in a variable entries section of a variable entries page that was first presented to the first user.

4. The computer-assisted method of claim 1 wherein the comparison report includes a proposed resolution of at least one interpreted difference between the first set of parameters and the second set of parameters of the second electronic variable data document.

5. The computer-assisted method of claim 1 wherein the at least one interpreted difference between the first set of parameters and the second set of parameters includes: (i) a numerical difference; and (ii) a description of the numerical difference as increased or decreased.

6. The computer-assisted method of claim 1 wherein the at least one interpreted difference between the first set of parameters and the second set of parameters includes a description of the difference selected from the group consisting of: increased, decreased, removed, added, changed, and unchanged.

7. The computer-assisted method of claim 1 wherein the second electronic variable data document is selected from the group consisting of: a document from a prior transaction with the same second user, a document from a prior transaction with a different second user, a document from an earlier version of the second electronic variable data document with the same second user in the same transaction, and a document from an alternative second user in the same transaction.

8. The computer-assisted method of claim 1 further comprising:
(f) obtaining from the second user the third electronic variable data document having a third set of parameters, at least one parameter generated from the second user accepting, rejecting or countering the parameters of the first electronic variable data document;
(g) comparing with the computer system the third electronic variable data document to the first electronic variable data document, the first electronic variable data document having the first set of parameters corresponding to answered questions provided by the first user;
(h) identifying with the computer system differences between the third set of parameters of the third electronic variable data document and the first set of parameters of the first electronic variable data document, wherein the differences are categorized and labeled;
(i) generating with the computer system a comparison report including the categorized and labeled differences and an interpretation of identified differences between the third set of parameters and the first set of parameters, the comparison report including a proposed resolution for at least one interpreted difference between the first set of parameters and the third set of parameters, wherein the first user provides additional input by accepting, rejecting, or revising the proposed resolution;
(j) generating with the computer system a fourth electronic variable data document file incorporating the additional input; and
(k) storing the accepted, rejected and countered parameters in a third electronic variable data document.

9. The computer-assisted method of claim 2 further comprising:
(g) displaying a variable entries page having a variable entries section and a source document section, wherein source document section displays differences between the parameters in the first electronic variable data document and the third electronic variable data document input by the second user.

10. A computer-assisted method for assisting users in evaluating a set of parameters in an electronic document representing a first transaction between at least two parties comprising:
(a) receiving at a computer system a plurality of first documents generated by a plurality of users interested in entering a transaction with a party, each document comprising a set of parameters corresponding to answers provided by one of the plurality of users to a set of predefined choices and/or interview questions;
(b) comparing with the computer system at least one of the plurality of first documents to at least another one of the first documents to identify differences between the sets of parameters in the documents; and
(c) reporting in a comparison file generated by the computer system, the comparison file having an accept, reject or counter selector, an interpretation of identified differences between the sets of parameters.

11. The computer-assisted method of claim 10 further comprising:
(d) providing additional input by accepting, rejecting, or countering each of the parameters; and
(e) generating by the computer system a second document with a third set of parameters.

12. The computer-assisted method of claim 10 further comprising:
(d) comparing with the computer system the at least one of the plurality of first documents to a document having a set of parameters received from one of the plurality of users from a different transaction.

13. The computer-assisted method of claim 10 further comprising:
(d) generating with the computer system a plurality of second documents incorporating the additional input of the party, wherein certain parameters in the second documents are outside the scope of the answered questions provided by the plurality of users.

14. The computer-assisted method of claim 13 further comprising:
(e) receiving, by one of the plurality of users, one of the second documents from the user;
(f) comparing with the computer system the second document to the first document generated by the one user; and
(g) reporting by the computer system in a second comparison file having an accept, reject or counter selector for the one lender (i) an interpretation of identified differences between a set of parameters; and (ii) a proposed resolution.

15. A computer-assisted method for assisting a user in evaluating a set of parameters in multiple electronic documents representing a potential first transaction between at least two parties comprising:
(a) obtaining a plurality of electronic documents from a set of third parties, each electronic document having a set of parameters corresponding to a relevant transaction;
(b) comparing with a computer system each of the plurality of electronic documents to a reference document to generate a comparison report interpreting differences between the sets of parameters in the plurality of electronic documents and the reference document and providing a proposed resolution of the differences for at least one parameter, wherein the user provides additional input by accepting, rejecting, or revising each proposed resolution;
(c) generating with the computer system a second set of electronic documents incorporating the additional input of the user, wherein the sets of parameters in each document are customized for each third party; and
(d) storing the accepted, rejected and revised parameters made by the user in a computer memory.

16. The computer-assisted method of claim 15 wherein the at least one interpreted difference between the first set of parameters and the second set of parameters includes: (i) a numerical difference; and (ii) a description of the numerical difference.

17. A computer system for assisting a user in evaluating a set of parameters in multiple electronic documents representing a potential first transaction between at least two parties, the computer system having one or more processors, one or more computer-readable storage devices and program instructions stored on at least one of the one or more storage devices for execution by at least one of the one or more processors, the program instructions comprising:
(a) program instructions to compare a first electronic variable data document having variable entries corresponding to a first set of parameters from a first electronic negotiated document to a second electronic variable data document, the second electronic variable data document having variable entries corresponding to a second set of parameters from a second electronic negotiated document;
(b) program instructions to identify differences between the first set of parameters of the first electronic variable data document and the second set of parameters of the second electronic variable data document, wherein the differences are categorized and labeled;
(c) program instructions to generate a comparison report including the categorized and labeled differences and an interpretation of the identified differences between the first set of parameters of the first electronic variable data document and the second set of parameters of the second electronic variable data document, wherein a second user provides additional input by accepting, rejecting, or countering each of the parameters of the first electronic variable data document; and
(d) program instructions to store the accepted, rejected and countered parameters in a third electronic variable data document.

18. The computer system of claim 17 further comprising:
(e) program instructions, stored on at least one of the one or more storage devices for execution by at least one of the one or more processors, to obtain from the second user the third electronic variable data document having a third set of parameters, at least one parameter generated from the second user accepting, rejecting or countering the parameters of the first electronic variable data document;
(f) program instructions to compare the third electronic variable data document to the first electronic variable data document, the first electronic variable data document having the first set of parameters corresponding to answered questions provided by the first user;
(g) program instructions to identify differences between the third set of parameters of the third electronic variable data document and the first set of parameters of the first electronic variable data document, wherein the differences are categorized and labeled;
(h) program instructions to generate a comparison report including the categorized and labeled differences and an interpretation of identified differences between the third set of parameters and the first set of parameters, the comparison report including a proposed resolution for at least one interpreted difference between the first set of parameters and the third set of parameters, wherein the first user provides additional input by accepting, rejecting, or revising the proposed resolution;
(i) program instructions to generate a fourth electronic variable data document file incorporating the additional input; and
(j) program instructions to store the accepted, rejected and countered parameters in a third electronic variable data document.

19. A computer-assisted method for assembling an electronic document comprising the steps of:
(a) displaying in a first area of a display screen a set of predefined questions and/or choices relating to a set contractual provisions in an electronic document and in a second area of the display screen the set of contractual provisions; and
(b) populating contemporaneously, by a computer system, in response to a first user answering the set of predefined questions and/or selections to predefined options corresponding to the set of contractual provisions, the set of variable entries included in predefined contractual provisions in the second area of the display screen to provide the first user a real-time revision of the electronic document.

20. The computer-assisted method for assembling an electronic document of claim 19 further comprising:
(c) displaying differences between the predefined contractual provisions and the contractual provisions input by a first user.
